(19) United States
(12) Patent Application Publication
(10) Pub. No.: US 2006/0118737 A1
(43) Pub. Date: Jun. 8, 2006

(54) Device for influencing,deflecting and/or reflecting preferably electromagnetic, terrestrial and atmospheric radiation or fields having a natural or technical origin

(76) Inventor: Adolf Wiebecke, Oberalm (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/555,688

(22) PCT Filed: Jan. 15, 2004
(86) PCT No.: PCT/AT04/00004

§ 371 Date: Dec. 14, 2005

(30) Foreign Application Priority Data
May 6, 2003 (AT) GM 312/2003

(51) Int. Cl. H01J 5/18; G21K 1/00

(52) U.S. Cl. 250/505.1

(57) ABSTRACT

The invention relates to a device for influencing, deflecting and/or reflecting preferably electromagnetic, terrestrial and atmospheric radiation or fields of natural or technical origin, especially from geopathogenic zones. The device of the invention comprises a preferably flat element (1), which may be positioned in the floor, wall or ceiling area of a room, with meandering or parallel running hose or tube elements (5) containing energetically influenced and/or informed water. The device is of compact and economical design and can be deployed in a simple manner in rooms or buildings to be shielded.

The invention relates to a device for influencing, deflecting and/or reflecting preferentially electromagnetic, terrestrial and atmospheric radiation or fields of natural or technical origin, in particular from geopathogenic zones.

As has already been described in a large number of scientific studies, terrestrial radiation or fields and atmospheric radiation from diverse natural or artificial sources exert harmful effects on humans, animals and vegetation, if such energy flows are concentrated in so-called noxious zones or are superposed in a harmful fashion. Such noxious zones may exist for instance above water veins (geologically termed “strands of water”) or tectonic faults and are subsumed under the term of geopathogenic zones in the literature. In the interior of buildings or apartments such fields or radiations may be amplified or superposed or adversely deflected in particular by metal structures or elements such as beams, pipes or masts, but also by stone, concrete or other materials.

From DE 38 37 622 A1 a device has become known in this context for the shielding and absorption of radiation of electro-magnetic DC-fields originating in subterranean water veins (earth radiation). The device uses a magnetic plate which is mounted against the direction of radiation, the length of which plate depends on the width of the radiation field and which thus shields from terrestrial radiation. Above and behind the magnetic plate space should be free of radiation. The magnetic plate is made from sheet steel and is magnetised by a DC electromagnet or by a rod-shaped permanent magnet.

From DE 34 33 292 A1 a device is known for the directed deflection or shielding of terrestrial rays coming from geopathogenic zones or other noxious sources, such as TV-antennas or high-voltage transmission towers. The device consists of a V-shaped multi-element rod antenna made of conductive material, at whose upwardly directed opening a reflector shield is provided which deflects, radiation downwards. The device is placed in a cylindrical housing serving as a container for filling material and as a support. The bottom of the housing may be configured as a reflector for increased effectiveness. The V-shaped rod antenna, when placed in a noxious zone, supposedly generates radiation which is reflected by the shield or the reflector in a suitable way. This radiation is supposed to change the noxious field and thus eliminate the noxious effect.

From EP 0 642 807 A2 there has become known in this context an essentially rectangular pad which is provided with a series of magnetic strips aligned parallel to the short side of the rectangular pad. A conductive element consisting of a bundle of conductors is positioned at the edge of the pad, whose characteristic vibrations are excited by the earth's magnetic field, thus reducing the geopathogenic influences in the area of the pad. Disadvantageously, the claimed effect is essentially confined within the dimensions of the pad.

It is the object of the present invention to further improve a device for the influencing, deflecting and/or reflecting of preferentially electromagnetic, terrestrial and atmospheric radiations and fields of natural or technical origin in such a way that a compact and economical design is achieved, while the effect on humans and other living beings in its range of influence will be improved or remain at least the same, and that simple deployment of the device is possible in the rooms or buildings to be shielded. A further aim is an unobtrusive appearance of the device.

According to the invention this object is achieved by proposing a preferentially flat element, which can be positioned on the floor, wall or ceiling of a room, with meandering or parallel running hose or tube elements containing energetically influenced or informed water. Preferably the flat element is to be integrated in a wall, floor or ceiling panel, such that the meandering or parallel running hose or tube elements form a closed system filled with energetically influenced water in a first variant of the invention.

The term “informed water” in this context is applied to natural water (e.g. water of certain springs) or especially treated water which has encoded certain energetic and/or material information in the cluster structure of the water molecules. This can be explained by the dipole character of the water molecule, which in liquid water is not present as a single molecule, but forms diverse arrangements or configurations of molecule groups, i.e. so-called cluster structures. The binding energy of hydrogen bridges is high, causing the water molecules to form crystal-like structures. In non-informed water the hydrogen bridges are continuously breaking down and new clusters are formed. “Water information” causes an impressed, i.e. stable cluster structure due to a resonance coupling which stabilises the hydrogen bridges. This cluster structure can only be destroyed by energy input, such as strong magnetic fields, laser- or X-rays, strong heat and high pressure. The cluster eigenvalues (=information) occurring in this process lie in the hertz to kilohertz range.

In a second variant of the invention the flat element has fittings for feeding water into and draining water from the meandering or parallel running hose or tube elements, a device for energetically influencing the water flow passing through the water inlet being placed within this inlet or in a position preceding it. Preferably the device for energetically influencing the water flow may be integrated in a floor, wall or ceiling heating or cooling system, such that the water containing elements, besides their primary purpose of heating or cooling the room, may also be used for positively influencing terrestrial or atmospheric radiation or fields of natural or technical origin, thus exerting a positive effect on the living beings present in the room.

In a preferred variant the device for energetically influencing the water flow is provided with a sealable vessel, which is preferably placed in a T-section, and is immersed in the water flow and can be filled with informed water.

The informed water contained in the vessel transfers its information to the water flow in the preferably flat element, or informed water may be introduced directly into the flat element, whereupon an influence on or neutralization of the noxious components of terrestrial or atmospheric radiation in the region of the flat element will be observed. It can also be shown that the harmful effects of fields or radiations from geopathogenic zones or artificial technical sources on humans or other living beings will be significantly reduced and that the achieved improvement of the room climate will result in a kind of harmonizing equilibration. The harmonizing effect will be felt at least in the room in which the flat element is placed on the wall, on the floor or preferably on the ceiling. Buildings or rooms furnished with such flat elements or with modified heating or cooling elements can thus eliminate or neutralize the harmful effects of noxious zones in a simple manner. People living and working in such rooms will exhibit considerably fewer symptoms of stress and will have improved regulatory and defensive powers, which again may have a positive effect on their well-being, work performance and potential aggressive tendencies.

A similar effect may be attained if in a further development of the invention the device for energetically influencing the water flow is provided with a holder for a crystal, with the crystal immersed in the water flow, or if the device for energetically influencing the water flow is provided with a water-permeable receptacle, preferably a sieve, which is filled with loose crystals or crystal chips and~where the water flow passes through the receptacle and flows around the crystals. Suitable materials are for instance quartz crystals and other silicates, preferably rock crystal, rose quartz, amethyst and the like, but also crystals and matrix of other composition.

In the case of a ceiling cooling system or a floor heating system the water outlet is conventionally connected with the water inlet via a circulation pump, with heating or cooling equipment, for instance in the form of a heat exchanger, being positioned in front of or behind the circulation pump.

It will be of advantage if the device for energetically influencing the water flow is positioned upstream of the circulation pump.

The invention will also permit that a number of flat elements are connected in series.

The invention will now be explained in more detail with reference to the attached drawings, wherein

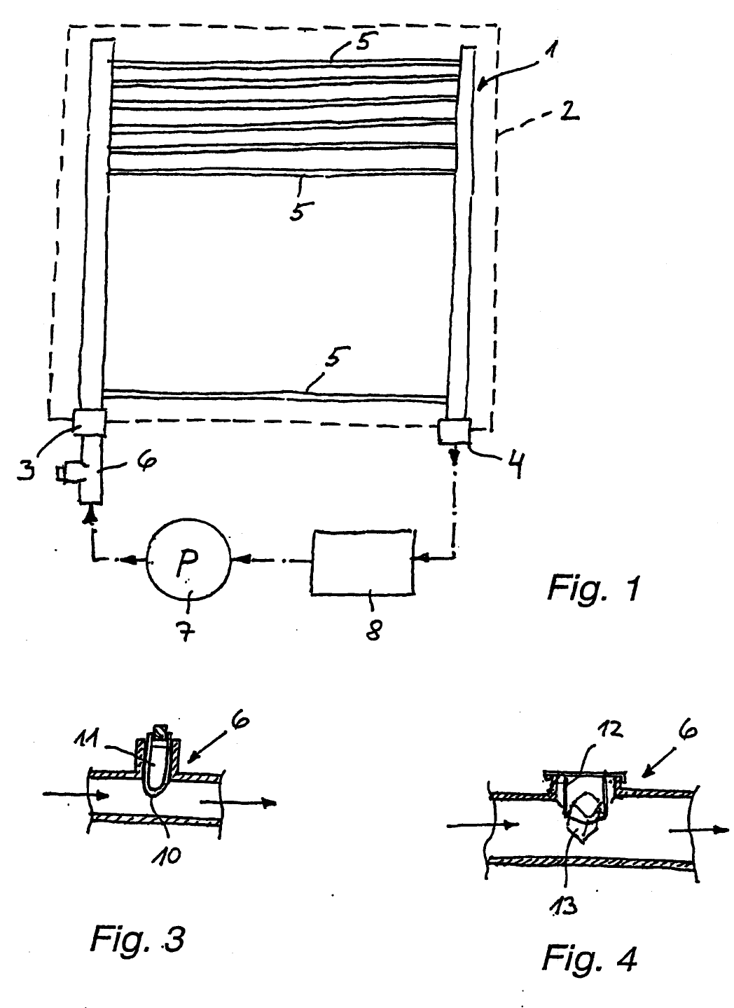

FIG. 1 shows a schematic view of a device according to the invention for influencing, deflecting and/or reflecting terrestrial or atmospheric radiations or fields;

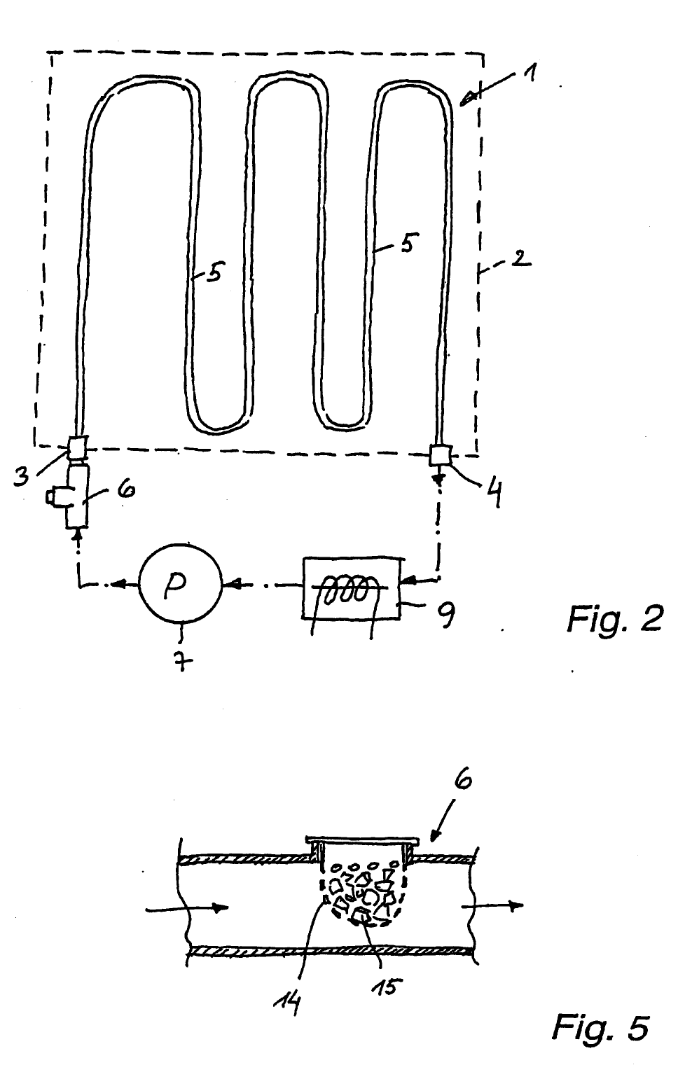

FIG. 2 shows a variant of the device of FIG. 1;

FIG. 3 to FIG. 5 show diverse variants of the device for energetically influencing the water flow;

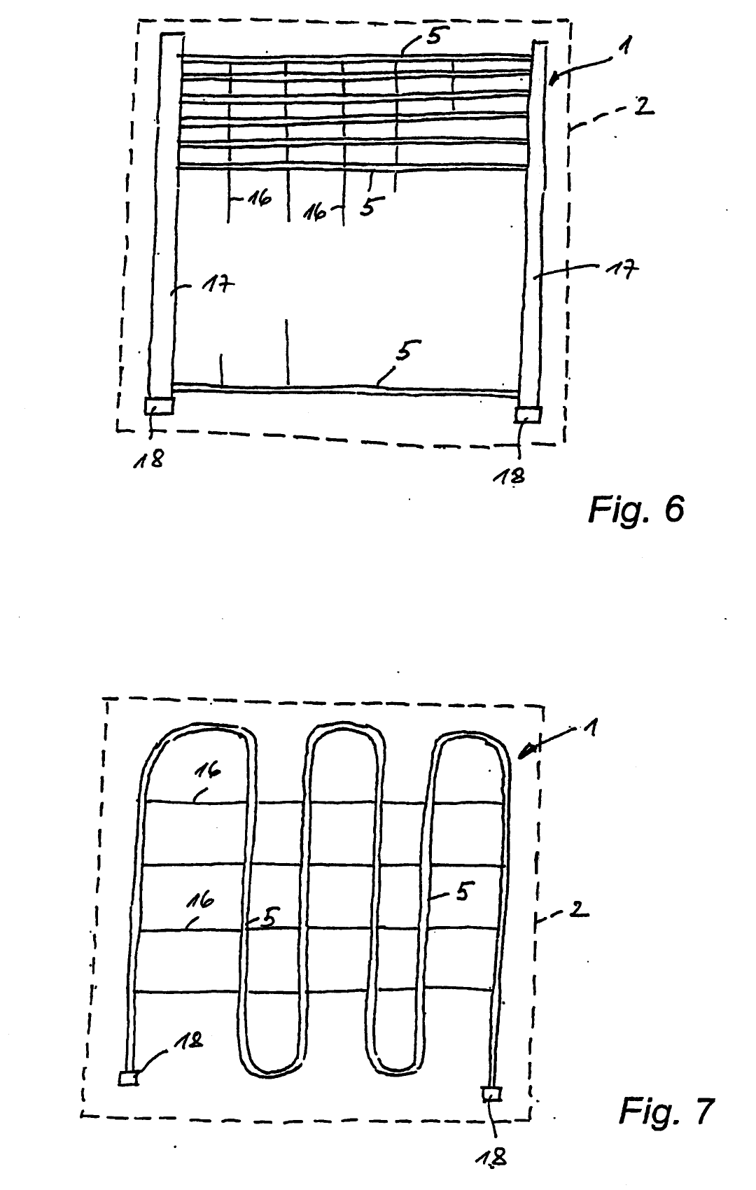

FIG. 6 and FIG. 7 are two variants of the device according to the invention in the form of closed systems.

The device as shown in FIG. 1 may for instance be part of a ceiling cooling system, with the flat element 1 integrated in a ceiling panel 2, which is indicated by dashed lines, or simply laid out on the upwards facing side of a suspended ceiling. The flat element 1 shown in FIG. 1 is provided with a water inlet 3, a water outlet 4, and a multitude of parallel running hose or tube elements 5, through which the water flow circulates.

A device 6 for energetically influencing or informing the water flow entering through the water inlet is placed in the area of the water inlet 3. The water outlet 4 is connected in a known way via a circulation pump 7 with the water inlet, with a cooling unit 8 being positioned upstream of the circulation pump 7 in the example shown. The circulation pump 7 may be operated even if the heating or cooling system is not active, at least part of the time.

As shown in the variant of FIG. 2 the flat element 1 may be part of a floor heating system, with the device 6 for energetically influencing the water flow being placed in front of the water inlet 3, as in the variant of FIG. 1. In this case the circuit contains a heating unit 9, for instance a heat exchanger. The connection between water inlet 3 and water outlet 4 is in this case configured as a meandering hose or tube element 5.

In the variant shown in FIG. 3 the device 6 for energetically influencing the water flow is provided with a vessel 10 dipping into the water flow and filled with informed water 11. As shown, the configuration preferentially may have the form of a T-section.

According to the variant shown in FIG. 4 the device 6 for energetically influencing the water flow may be provided with a holder 12 for a crystal 13, with the crystal 13 immersed in the water flow.

Finally, FIG. 5 shows a further variant, in which the device 6 for energetically influencing the water flow is provided with a water-permeable receptacle 14, which is filled with loose crystals or crystal chips. The water flow passing through the water-permeable receptacle, which may be configured as a sieve, comes into contact with the crystals, and thus the water is energetically influenced or informed.

In the variant of the invention shown in FIG. 6 the flat element 1 has parallel running hose elements 5 issuing from base sections 17 on both sides and thus forming a closed ladder element. The base sections 17 have sealing elements 18, which permit the system to be filled with informed water. The flat ladder element 1 may simply be laid on the upwards facing side of a suspended ceiling or may be integrated in a wall, floor or ceiling panel 2 indicated by dashed lines.

The variant of FIG. 7 differs from that of FIG. 6 by consisting mainly of a meandering hose or tube element 5. In both variants the meandering or parallel running hose or tube elements 5 may also be provided with connecting or supporting elements 16 made from wire or plastic material, thus forming a mat-like structure for easy laying.

1. Device for influencing, deflecting and/or reflecting terrestrial and atmospheric radiation or fields of natural or technical origin, in particular from geopathogenic zones, wherein a preferentially flat element which may be positioned in the floor, wall or ceiling area of a room, with meandering or parallel running hose or tube elements containing energetically influenced water.

2. Device according to claim 1, wherein the meandering or parallel running hose or tube elements form a closed system.

3. Device according to claim 1, wherein the flat element has a water inlet and a water outlet providing water for the meandering or parallel running hose or tube elements, with at least one device for energetically influencing the water flow entering via the water inlet being placed in front of or in the water inlet.

4. Device according to claim 3, wherein the device for energetically influencing the water flow is provided with a sealable vessel, preferentially positioned in a T-section, which dips into the water flow and can be filled with informed water.

5. Device according to claim 3, wherein the device for energetically influencing the water flow is provided with a holder for a crystal, with the crystal immersed in the water flow.

6. Device according to claim 3, wherein the device for energetically influencing the water flow is provided with a water-permeable receptacle, preferably a sieve, which is filled with loose crystals or crystal chips, with the water flow passing through the water-permeable receptacle and flowing around the crystals.

7. Device according to claim 1, wherein the water outlet is connected to the water inlet via a circulation pump, with a heating or cooling unit being positioned in front of or behind the circulation pump.

8. Device according to claim 7, wherein the device for energetically influencing the water flow is placed upstream of the circulation pump.

9. Device according to claim 1, wherein the meandering or parallel running hose or tube elements are disposed in ladder-like fashion and are provided with connecting or supporting elements.

10. Device according to claim 1, wherein a multitude of flat elements may be connected in series.

11. Device according to claim 1, wherein the flat element is laid out on the upwards facing side of a suspended ceiling.

12. Device according to claim 1, wherein the flat element is integrated in a wall, floor or ceiling panel.
